(19) United States
(12) Patent Application Publication
(10) Pub. No.: US 2006/0066993 A1
(43) Pub. Date: Mar. 30, 2006

(54) Disk drive device

(75) Inventors: Masaya Agematsu, Akishima-shi (JP); Yasushi Tomizawa, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/228,248

(22) Filed: Sep. 19, 2005

(30) Foreign Application Priority Data
Sep. 30, 2004 (JP) 2004-286540

(51) Int. Cl. G11B 33/14

(52) U.S. Cl. 360/97.03

(57) ABSTRACT

A plurality of magnetic disks are supported and rotated by a motor that is arranged in a case. A stabilizing plate is located between the disks so as to oppose surfaces of the disks across gaps. The stabilizing plate includes integrally with an arcuate first stabilizing portion and a second stabilizing portion. The first stabilizing portion has a first peripheral edge extending along respective outer peripheral edges of the disks and a second peripheral edge opposed to the first peripheral edge across a gap, and is opposed to the whole respective outer peripheral edge portions of the disks except a movement region for a carriage assembly. The second stabilizing portion radially extends from one end portion of the first stabilizing portion toward respective central parts of the disks and is opposed to the movement region for the carriage assembly.

### CROSS-REFERENCE TO RELATED APPLICATIONS

This application is based upon and claims the benefit of priority from prior Japanese Patent Application No. 2004-286540, filed Sep. 30, 2004, the entire contents of which are incorporated herein by reference.

### BACKGROUND OF THE INVENTION

1. Field of the Invention

This invention relates to a disk drive device, such as a magnetic disk drive, provided with disks configured to rotate at high speed.

2. Description of the Related Art

In general, a magnetic disk drive comprises magnetic disks, a spindle motor that supports and rotates the disks, a carriage assembly that supports magnetic heads, a voice coil motor that drives the carriage assembly, a board unit, etc, which are located in a case.

The spindle motor has a cylindrical hub, on which the magnetic disks and spacer rings are alternately stacked in layers. The disks and the rings are fixed on the hub by a disk damper that is attached to the distal end of the hub.

In the magnetic disk drive of this type, the rotational frequency of the magnetic disks must be increased to ensure high-speed data processing. Magnetic disk devices of a high-rotation type have been investigated in recent years. If the magnetic disks rotate at high speed, however, airflows in the same direction as the rotation direction of the disks are produced inevitably. If they are disturbed, a phenomenon called disk flutter is caused such that the magnetic disks vibrate. Further, the turbulent flows cause the carriage assembly to vibrate. In this case, the positioning accuracy for the magnetic heads with respect to the disks lowers and hinders the improvement of the recording density.

Proposed in Jpn. Pat. Appln. KOKAI Publication No. 2000-322870, for example, in order to solve these problems, is a magnetic disk device that is provided with a shroud for smoothing airflows in the circumferential direction of magnetic disks that are produced as the disks rotate. This shroud is an arcuate structure that surrounds the outer peripheries of the disks. Comb teeth are arranged on those parts of the peripheral surface which are free from the shroud. They are interposed between the disks so that they penetrate their outermost peripheries and get into their inner peripheries.

A configuration for the improvement of head positioning operation is proposed in Jpn. Pat. No. 3348418, for example. According to this configuration, stabilizing blades are arranged on the downstream side of a carriage assembly, whereby production of turbulent flows around a carriage is restrained to reduce vibration of the carriage assembly.

In incorporating the shroud into the magnetic disk device constructed in this manner, however, it must be laterally inserted between the magnetic disks that are stacked in layers. Therefore, assembling the device is difficult and requires complicated manufacturing processes.

An alternative configuration may be proposed in which the shroud and the stabilizing blades for rectifying turbulent flows that hit the carriage assembly are mounted individually in separate cases. In a relatively large-sized magnetic disk device that uses disks of 3.5 inches or more, those members can be mounted with ease because of the relatively generous external shape of the device. In a small-sized magnetic disk device that uses disks of 2.5 inches or less, however, its limited mounting space makes it hard to mount those members. Further, its assembly processes swell, thus entailing an increase in manufacturing costs.

### BRIEF SUMMARY OF THE INVENTION

According to an aspect of the invention, there is provided a disk drive unit comprising: a case; a motor arranged in the case; a plurality of disks which are individually supported and rotated by the motor; a head which processes information for the disks; a carriage assembly which is arranged in the case and supports the head for movement with respect to the disks; and a stabilizing plate located between the plurality of disks and opposed to surfaces of the disks across gaps. The stabilizing plate includes an arcuate first stabilizing portion which has a first peripheral edge extending along respective outer peripheral edges of the disks and a second peripheral edge opposed to the first peripheral edge across a gap and which is opposed to the whole respective outer peripheral edge portions of the disks except a movement region for the carriage assembly; and a second stabilizing portion, which radially extends from one end portion of the first stabilizing portion toward respective central parts of the disks and is opposed to the movement region for the carriage assembly.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a hard disk drive (hereinafter referred to as an HDD) according to a first embodiment of the invention;

FIG. 2 is a sectional view of the HDD taken along line II-II of FIG. 1;

FIG. 3 is a sectional view of the HDD taken along line III-III of FIG. 1;

FIG. 4 is a plan view showing a stabilizing plate of the HDD;

FIG. 5 is a diagram showing the relation between the stabilizing plate area ratio and the increment of current consumption;

FIG. 6 is a diagram showing the relation between the stabilizing plate area ratio and the rate of improvement of positioning accuracy;

FIG. 7 is a plan view showing a modification of the stabilizing plate;

FIG. 8 is a plan view showing another modification of the stabilizing plate;

FIG. 9 is a plan view showing a stabilizing plate of an HDD according to a second embodiment of the invention;

FIG. 10A is a sectional view of the HDD of the second embodiment taken along line XA—XA of FIG. 9;

FIG. 10B is a sectional view of the HDD of the second embodiment taken along line XB—XB of FIG. 9;

FIGS. 11A, 11B and 11C are sectional views individually showing modifications of the stabilizing plate of the HDD of the second embodiment;

FIG. 12 is a sectional view showing a stabilizing plate according to another embodiment of the invention; and

FIG. 13 is a sectional view showing a stabilizing plate according to still another embodiment of the invention.

### DETAILED DESCRIPTION OF THE INVENTION

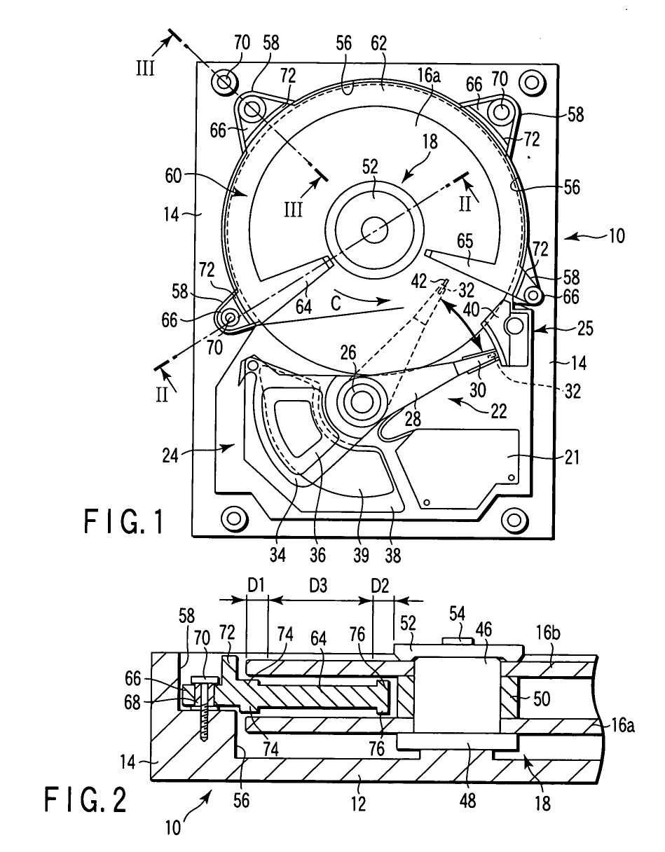

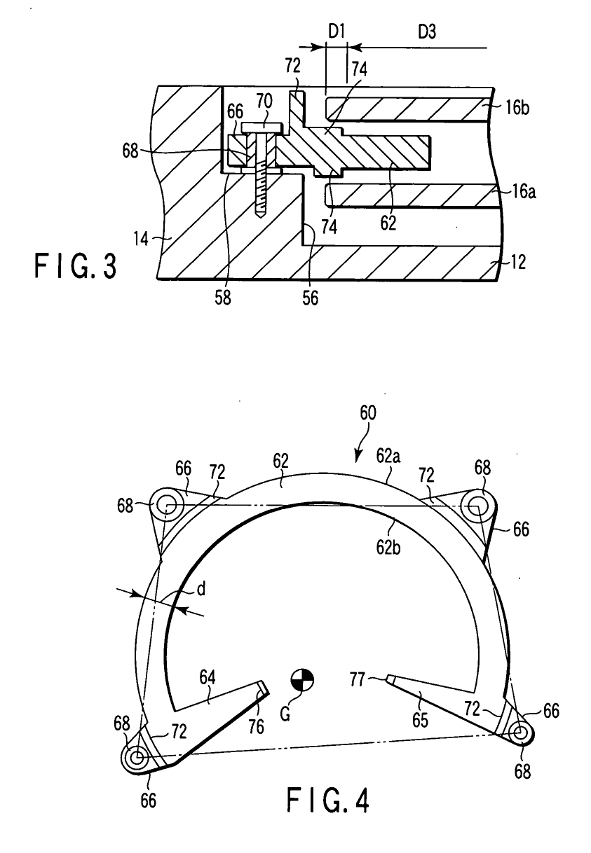

An HDD as a disk drive unit according to a first embodiment of this invention will now be described in detail with reference to the accompanying drawings. As shown in FIGS. 1 to 3, the HDD comprises a case 10 that serves as a base. The case 10 integrally has a rectangular bottom wall 12 and a sidewall 14 set up on the periphery of the bottom wall, and is formed in the shape of an open-topped rectangular box. An opening of the case 10 is closed by a top cover (not shown) that is fixed to the sidewall 14 by screws.

Arranged in the case 10 are a spindle motor 18 mounted on the bottom wall 12 and two magnetic disks 16a and 16b that are supported and rotated by the spindle motor 18. The upper magnetic disk 16b is not shown in FIG. 1. The case 10 contains magnetic heads, a carriage assembly 22, a voice coil motor (VCM) 24, a ramp load mechanism 25, and a board unit 21 having a preamplifier and the like. The magnetic heads are used to record and reproduce information to and from the disks 16a and 16b. The carriage assembly 22 supports the heads for movement with respect to the disks 16a and 16b. The VCM 24 rotates and positions the carriage assembly. The ramp load mechanism 25 holds the magnetic heads in a shunt position off the magnetic disks 16a and 16b when the heads are moved to the outermost peripheries of the disks. A printed circuit board (not shown) for controlling the respective operations of the spindle motor 18, VCM 24, and magnetic heads through the board unit 21 is screwed to the outer surface of the bottom wall 12.

The carriage assembly 22 has a bearing portion 26 fixed on the bottom wall 12 and four arms 28 extending from the bearing portion. These arms 28 extend parallel to the surfaces of the magnetic disks 16a and 16b in the same direction from the bearing portion 26 and are situated at given spaces from one another. The carriage assembly 22 is provided with suspensions 30 each in the form of an elastically deformable elongate plate. Each suspension 30 is formed of a leaf spring, of which the proximal end is fixed to the distal end of its corresponding arm 28 by spot welding or adhesive bonding, and which extends from the arm. Alternatively, each suspension 30 may be formed integrally with its corresponding arm 28.

A magnetic head 32 is mounted on an extended end of each suspension 30. The magnetic head 32 has a substantially rectangular slider and a magnetic resistance (MR) head for recording and reproduction formed on the slider. The head 32 is fixed to a gimbals portion that is formed on the distal end portion of the suspension 30. The four magnetic heads 32 that are mounted individually on the suspensions 30 are opposed two to two and arranged so as to hold the magnetic disks from both sides.

The carriage assembly 22 has a support frame 34 that extends from the bearing portion 26 in the direction opposite from the arm 28. This support frame supports a voice coil 36 that constitutes a part of the VCM 24. The support frame 34 is a synthetic resin structure molded integrally on the outer periphery of the voice coil 36. The voice coil 36 is situated between a pair of yokes 38 (only one of which is shown) that are fixed on the bottom wall 12. The voice coil 36, along with these yokes and a magnet 39 fixed to one of the yoke, constitutes the VCM 24. When the voice coil 36 is energized, the carriage assembly 22 rotates around the bearing portion 26, and the magnetic heads 32 are moved to and positioned on desired tracks of the magnetic disks 16a and 16b. The carriage assembly 22 and the VCM constitute a head actuator.

The ramp load mechanism 25 comprises a ramp 40 and tabs 42 that extend individually from the respective distal ends of the suspensions 30. The ramp 40 is provided on the bottom wall 12 and located outside the magnetic disks 16a and 16b. As the carriage assembly 22 rotates so that the magnetic heads 32 rotate to their shunt position outside the magnetic disks 16a and 16b, the tabs 42 engage a ramp surface on the ramp 40. Thereafter, the tabs 42 are pulled up by the inclination of the ramp surface to unload the magnetic heads 32.

As shown in FIG. 2, each of the magnetic disks 16a and 16b has a diameter of 65 mm (2.5 inches) and is bored in its central part. Each of the upper and lower surfaces of each magnetic disk has a first no-data recording region D1 on its outer peripheral edge portion, a second no-data recording region D2 on its inner peripheral edge portion, and a data recording region D3 situated between the first and second first no-data recording regions.

The spindle motor 18 is provided with a hub 46 that serves as a rotor. The two magnetic disks 16a and 16b are coaxially fitted on the hub 46 and stacked in layers with a given space in the axial direction of the hub between them. The disks 16a and 16b are rotated integrally with the hub 46 at a given speed by the spindle motor 18.

More specifically, the hub 46 of the spindle motor 18 is in the form of a closed-topped cylinder. The hub 46 is rotatably supported on a spindle by a bearing (not shown). A flange-shaped disk receiving portion 48 is formed on the outer periphery of the lower end portion of the hub 46. The two magnetic disks 16a and 16b have their respective center bores penetrated by the hub 46 when they are fitted on the hub and put in layers on the disk receiving portion 48. Further, a spacer ring 50 is fitted on the hub 46 and sandwiched between the magnetic disks 16a and 16b. The ring 50 is in contact with the respective second no-data recording regions D2 of the disks 16a and 16b.

A disk-shaped disk damper 52 is fastened to the upper end face of the hub 46 by a screw 54. The outer peripheral portion of the disk clamper 52 engages the second no-data recording region D2 of the upper magnetic disk 16a, thereby pressing the two magnetic disks 16a and 16b and the spacer ring 50 toward the disk receiving portion 48 of the hub 46. Thus, the disks 16a and 16b and the ring 50 are sandwiched between the disk receiving portion 48 and the clamper 52 and fixedly held on the hub 46 in a close-contact state. The disk clamper 52 is rotated together with the hub 46 and the magnetic disks 16a and 16b in the direction of arrow C in FIG. 1.

That part of the sidewall 14 of the case 10 which is situated adjacent to the outside of the magnetic disks 16a and 16b has an arcuate inner surface 56 that faces the respective outer peripheral edges of the disks across a given gap, and forms a shroud. The sidewall 14 has four fixing portions 58 that are one level lower than its upper end face. The fixing portions 58 are formed by cutting some parts of the inner surface 56, four spots in this case, outward. A stabilizing plate (mentioned later) is mounted on the fixing portions 58.

As shown in FIGS. 1 to 4, the HDD is provided with a stabilizing plate 60 that stabilizes and smoothes airflows in the circumferential direction of the magnetic disks 16a and 16b that are produced as the disks rotate. The stabilizing plate 60 has a first stabilizing portion 62 having the form of a substantially C-shaped arc, a second stabilizing portion 64 radially extending from one end of the first stabilizing portion, and a third stabilizing portion 65 radially extending from the other end of the first stabilizing portion. The stabilizing plate 60 is integrally molded from synthetic resin, for example.

The first stabilizing portion 62 has a first peripheral edge 62a extending along the respective outer peripheral edges of the magnetic disks 16a and 16b and a second peripheral edge 62b that faces the first peripheral edge 62a across a gap. The first stabilizing portion 62 is opposed to the whole outer peripheral edge portions of the magnetic disks except a movement region for the carriage assembly 22. If the distance from the outer peripheral edge of each of the disks 16a and 16b to the second no-data recording region D2 is 100%, as mentioned later, a space d between the first and second peripheral edges 62a and 62b of the first stabilizing portion 62 is adjusted to 50% or less. The first stabilizing portion 62 stabilizes turbulent flows that are produced as the disks 16a and 16b rotate, thereby restraining vibration of the disks.

The second stabilizing portion 64 radially extends from one end portion of the first stabilizing portion 62 toward the respective central parts of the magnetic disks 16a and 16b so as to reach a position opposite the second no-data recording region D2. The second stabilizing portion 64 is tapered from its proximal end on the side of the first stabilizing portion 62 toward its extended end. With respect to the rotation direction C of the disks 16a and 16b, moreover, the second stabilizing portion 64 is situated on the upstream side of the movement region for the carriage assembly 22 and opposed to the movement region. Thus, the second stabilizing portion 64 reduces airflows that hit the carriage assembly 22, thereby restraining vibration of the carriage assembly.

The third stabilizing portion 65 radially extends from the other end portion of the first stabilizing portion 62 toward the respective central parts of the magnetic disks 16a and 16b so as to reach a position opposite the second no-data recording region D2. The third stabilizing portion 65 is tapered from its proximal end on the side of the first stabilizing portion 62 toward its extended end. With respect to the rotation direction C of the disks 16a and 16b, the third stabilizing portion 65 is situated on the downstream side of the movement region for the carriage assembly 22 and opposed to the movement region. Thus, the third stabilizing portion 65 stabilizes airflows near the carriage assembly 22, thereby restraining vibration of the carriage assembly.

The stabilizing plate 60 integrally has at least three (four in this case) support portions 66 that protrude individually outward from the outer peripheral edge of the first stabilizing portion 62. The four support portions 66 are arranged substantially regular intervals in the circumferential direction. Two of them are provided on the respective proximal end portions of the second and third stabilizing portions 64 and 65, individually. Each support portion 66 is formed having a through hole, in which a metallic collar 68 is fitted.

As shown in FIGS. 1 to 3, the four support portions 66 of the stabilizing plate 60 are located individually in the fixing portions 58 of the sidewall 14 of the case 10 and fastened to the fixing portions by screws 70 that are passed through the collars 68, individually. By receiving the bearing surfaces of the screws by the collars 68 that are embedded in the support portions 66, individually, in this case, the stabilizing plate 60 can be securely steadily supported without the possibility of resin settling attributable to a creep phenomenon or screw loosening. Further, the support portions 66 at the respective proximal ends of the second and third stabilizing portions 64 and 65 serve to increase the stiffness of the stabilizing portions, thereby reducing displacement that may be caused by application of impact, if any.

An arcuate partition wall portion 72 is set up integrally on each support portion 66. The partition wall portions 72 extend in alignment with the arcuate inner surface 56 so as to close the fixing portions 58. Thus, notches in the inner surface 56 can be closed to supplement a disk flutter reducing effect of the shroud.

In assembling the HDD, the stabilizing plate 60 is stacked on the magnetic disk 16a after the disk 16a is fitted on the hub 46 of the spindle motor 18. If the stability of the stabilizing plate 60 is poor, as this is done, the stabilizing plate placed on the fixing portions 58 of the case 10 may possibly tilt and touch the disk 16a, thereby damaging the disk. In order to prevent the stabilizing plate 60 from tilting when it is placed on the fixing portions 58, therefore, the stabilizing plate 60 is formed so that its center of gravity G is situated in a polygon that has the four support portions 66 as its vertices. More specifically, while the screws 70 are used to mount the stabilizing plate 60, as shown in FIG. 4, there are four screwed spots, the gravity center G is situated in a quadrangle defined by the spots.

As shown in FIGS. 2 to 4, the first stabilizing portion 62 integrally has first step portions 74 that individually face the respective first no-data recording regions D1 of the magnetic disks 16a and 16b and project toward the disks. The second stabilizing portion 64 integrally has second step portions 76 that individually face the respective second no-data recording regions D2 of the disks 16a and 16b and project toward the disks. The third stabilizing portion 65 integrally has third step portions 77 that individually face the respective second no-data recording regions D2 of the disks 16a and 16b and project toward the disks.

Gaps between the first, second, and third stabilizing portions 62, 64 and 65 and the respective surfaces of the magnetic disks 16a and 16b are adjusted to about 0.3 to 0.5 mm, while gaps between first, second, and third step portions 74, 76 and 77 and the disk surfaces are adjusted to about 0.2 to 0.3 mm.

If the stabilizing plate 60 is subjected to an impact, it may possibly undergo a displacement and run against the magnetic disks 16a and 16b. However, the first step portions 74 are provided individually on those parts of the first stabilizing portion 62 which face the respective first no-data recording regions D1 of the disks 16a and 16b. If the stabilizing plate 60 is displaced by the impact, therefore, the maximum displacement of the magnetic disks occurs at their outermost peripheries. Thus, the first step portions 74 touch the respective first no-data recording regions D1 of the disks, thereby restraining further displacement of the first stabilizing portion 62. Since no data are recorded in the first no-data recording regions D1, there is no possibility of data failure, so that high reliability can be enjoyed.

The second and third stabilizing portions 64 and 65 that project to the central parts of the magnetic disks 16a and 16b are displaced by a longer distance than any other parts when the impact is applied. In the present embodiment, the second and third step portions 76 and 77 are provided on the extended ends of the second and third stabilizing portions 64 and 65, respectively, and are opposed to the respective second no-data recording regions D2 of the disks 16a and 16b. If the second and third step portions 76 and 77 are displaced when subjected to the impact, therefore, the second and third step portions 76 and 77 touch the respective second no-data recording regions D2 of the disks 16a and 16b, thereby restraining further displacement of the second and third stabilizing portions. Since no data are recorded in the second no-data recording regions D2, there is no possibility of data failure, so that high reliability can be enjoyed.

According to the HDD constructed in this manner, the stabilizing plate 60 is provided between the magnetic disks 16a and 16b and located close to the disks without interfering with the magnetic heads 32 or the carriage assembly 22. The stabilizing plate 60 can stabilize airflows over the surfaces of the disks 16a and 16b that are produced as the disks rotate. Even when the disks 16a and 16b rotate at high speed, therefore, airflows that are produced near the disks can be stabilized to reduce a disk flutter that is attributable to turbulence. Thus, vibration of the magnetic disks can be reduced, so that the resulting HDD is improved in head positioning accuracy for the magnetic disks.

Since the first, second, and third stabilizing portions 62, 64 and 65 of the stabilizing plate 60 are formed integrally with one another, the number of components is reduced, so that the components can be easily mounted in a small-sized HDD. Besides, the stabilizing plate 60, a single component, can be built at one time into the unit to be assembled, so that the number of manufacturing processes can be reduced.

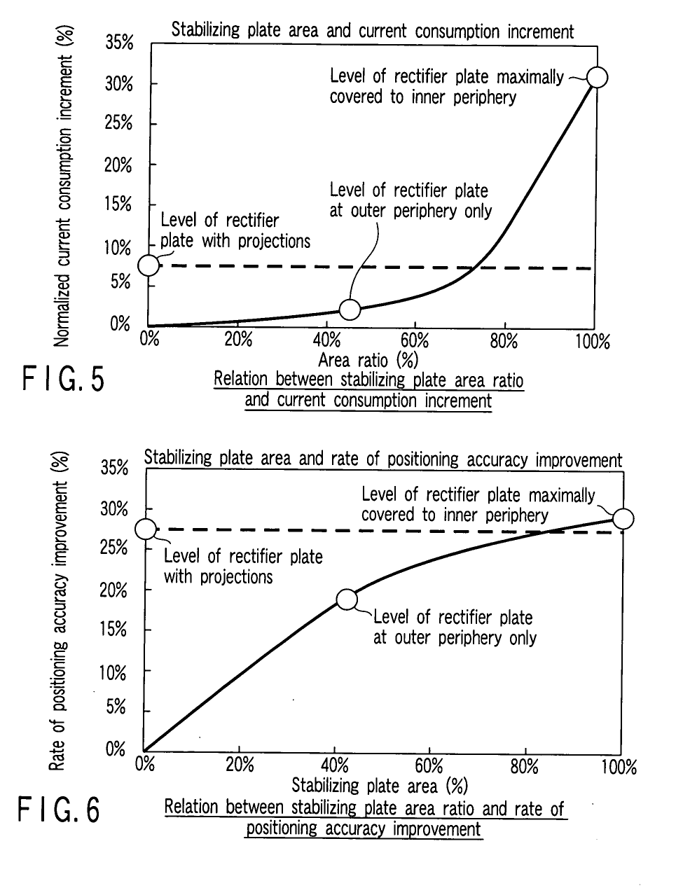

When compared with a stabilizing plate of a shape that also covers the inner peripheries of the magnetic disks 16a and 16b, the integrated stabilizing plate 60 can be improved in positioning accuracy without failing to restrain an increase in motor power consumption. If the stabilizing plate 60 is set near the magnetic disks, in general, windage loss of the magnetic disks increases, so that the current consumption of the spindle motor 18 increases inevitably. In FIG. 5, the abscissa and ordinate axes represent the stabilizing plate area ratio and the increment of current consumption, respectively. It is supposed, in this case, that the area ratio is zero when the stabilizing plate 60 is absent and that the area of the stabilizing plate that covers a region ranging from the outer peripheral edge of each magnetic disk to the second no-data recording region D2 at the inner periphery is 100%. As the area of the stabilizing plate 60 increases, as seen from FIG. 5, the current consumption increases gradually.

In FIG. 6, the abscissa and ordinate axes represent the stabilizing plate area ratio and the rate of improvement of the magnetic head positioning accuracy for the magnetic disks. If the area of the stabilizing plate 60 increases, as seen from FIG. 6, the degree of improvement of the positioning accuracy gradually decreases, although the positioning accuracy improves.

FIGS. 5 and 6 show a level for a stabilizing plate in which the region from the outer peripheral edge of each magnetic disk to the second no-data recording region D2 at the inner periphery (stabilizing plate maximally covered to its inner periphery), a level for the stabilizing plate of the present embodiment that has the first, second, and third stabilizing portions (stabilizing plate with projections), and a level for a stabilizing plate that has the first stabilizing portion only (stabilizing plate at the outer periphery only). As seen from these drawings, the stabilizing plate 60 according to the present embodiment, compared with the stabilizing plate maximally covered to its inner periphery, can enjoy a greater improvement effect for the positioning accuracy without failing to restrain the increase of current consumption.

In this case, the space d between the first and second peripheral edges 62a and 62b of the first stabilizing portion 62 of the stabilizing plate with projections is adjusted to about ¼ of the distance (difference in radius) from the outer peripheral edge from each disk to the second no-data recording region D2 at the inner periphery.

Thus, according to the present embodiment, the space d between the first and second peripheral edges 62a and 62b is adjusted to 50% or less, and preferably to 10% to 30%, if the distance (difference in radius) from the outer peripheral edge of each of the magnetic disks 16a and 16b to the second no-data recording region D2 is 100%.

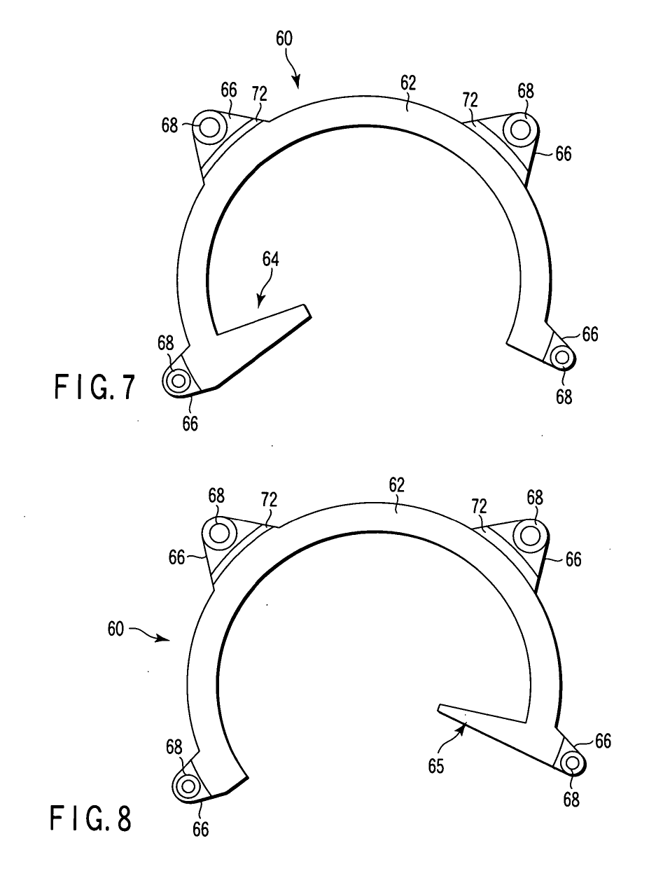

In the first embodiment described above, the stabilizing plate 60 is provided integrally with the first, second, and third stabilizing portions 62, 64 and 65. Alternatively, however, it may be configured to have first and second stabilizing portions 62 and 64 only, as shown in FIG. 7. As shown in FIG. 8, moreover, it may be configured to have first and third stabilizing portions 62 and 65 only. In a modification shown in FIG. 8, the third stabilizing portion 65 corresponds to a second stabilizing portion of this invention. The number of support portions 66 to be set in place is not limited to four but may be varied as required. Further, the partition wall portions of the support portions 66 on the proximal ends of the second and third stabilizing portions 64 and 65 may be omitted.

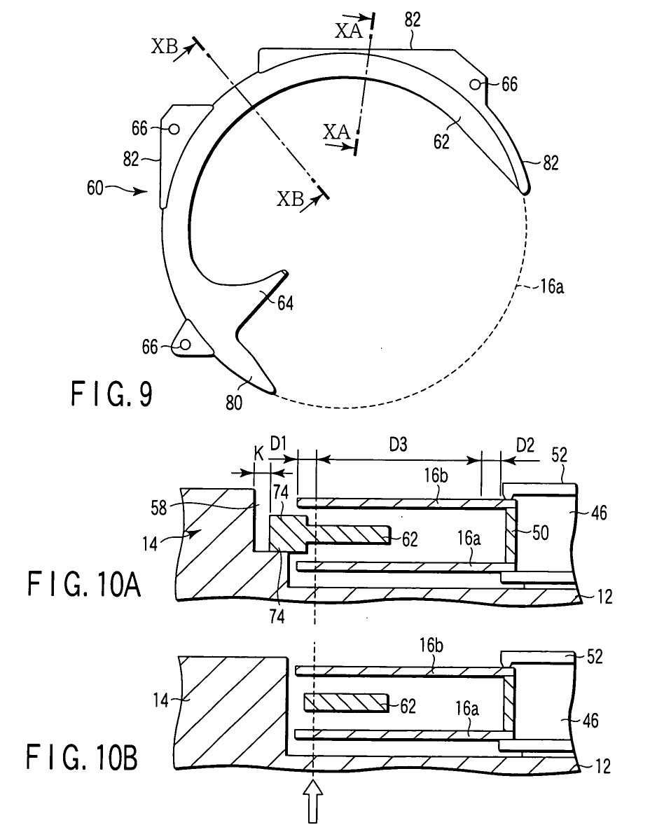

The following is a description of an HDD according to a second embodiment of this invention. According to the second embodiment, as shown in FIG. 9, a stabilizing plate 60 integrally has a first stabilizing portion 62 having the form of a substantially C-shaped arc and a second stabilizing portion 64 radially extending from one end of the first stabilizing portion. The second stabilizing portion 64 is situated on the upstream side of a movement region for a carriage assembly with respect to the rotation direction of a magnetic disk 16a. The second stabilizing portion 64 is tapered and extends to a position where it faces a second no-data recording region on the inner periphery of the magnetic disk 16a.

The stabilizing plate 60 integrally has a projection 80 that is formed on one end of the first stabilizing portion 62 and extends along the outer peripheral edge of the magnetic disk 16a and beyond the second stabilizing portion 64. The projection 80, like the first stabilizing portion 62, serves to cover the outer edge of the magnetic disk, thereby restraining its flutter. In order to reduce the influence of the disk flutter on the magnetic head positioning, the stabilizing plate should be configured to cover that part of the outer edge of the magnetic disk which is as near to the magnetic head as possible. The projection 80 can cover the outer edge of the magnetic disk to the nearest possible position for the magnetic head without regard to the position of the second stabilizing portion 64 and the screwed position of a support portion 66 at the proximal end of the second stabilizing portion. Thus, the disk flutter can be reduced more effectively.

As shown in FIG. 9, at least some parts of the first stabilizing portion 62, that is, regions near support portions 66 in this case, individually have extending portions 82 that extend outward beyond the outer peripheral edge of the magnetic disk 16a. As shown in FIG. 10A, first step portions 74 of the first stabilizing portion 62 are formed on the extending portions 82. As shown in FIG. 10B, those regions of the first stabilizing portion 62 which are not provided with the extending portions 82 have an outside diameter equal to or smaller than that of the magnetic disks 16a and 16b. In these regions, no anti-shock step portions are formed on the outer peripheral portion of the stabilizing plate.

In consideration of the manufacturability to mount the stabilizing plate 60 on the case 10, some fitting margin (gap) K should never fail to be provided between the stabilizing plate 60 and the case 10. If the gap K is generous, it may possibly be larger than the gap between the shroud of the case 10 and each magnetic disk. In this case, the outer periphery of the stabilizing plate 60 is located inside the outer peripheries of the magnetic disks. If the first step portions 74 are provided on the outer periphery of the stabilizing plate 60 in this state, their respective inside corners are situated inside the outermost peripheries of the data recording regions D3 of the magnetic disks 16a and 16b. Therefore, the data recording regions are damaged if they are subjected to an impact. In consequence, the is first step portions cannot produce their proper effects.

To avoid this, the fixing portions 58 of the case 10 are spread to be one size wider than the shroud so that the outer periphery of the stabilizing plate 60 is situated outside the respective outer peripheries of the magnetic disks 16a and 16b without failing to maintain the fitting margin K between the case 10 and the stabilizing plate, as shown in FIG. 10A. Thus, the first step portions 74 as anti-shock means are situated outside the outermost peripheries of the data recording regions D3 of the disks 16a and 16b. Therefore, the data recording regions cannot be damaged if they are subjected to an impact. If the first step portions 74 are provided on the first stabilizing portion 62, the extending portions 82 in which the outer periphery of the first stabilizing portion is outside the outer peripheries of the magnetic disks should be made as wide as possible. If possible, the extending portions should preferably be arranged covering the entire circumference.

In view of problems on the dimensions of the HDD and relations with other components, it is hard to arrange the extending portions 82 throughout the circumference of the first stabilizing portion 62. In this case, there exist regions that are not provided with the extending portions 82, as shown in FIG. 10B. For the reasons mentioned before, however, these regions should be left free from the anti-shock step portions. Even if the first step portions 74 are absent in some parts of the first stabilizing portion 62, the first step portions in adjacent parts can restrain the displacement of the magnetic disks. In consequence, therefore, the stabilizing plate never touches the magnetic disks, so that the data recording regions can be protected.

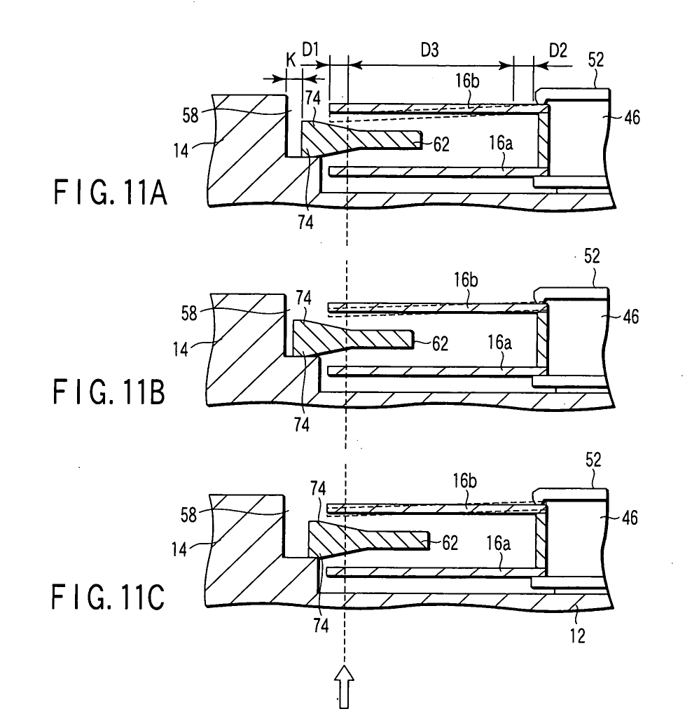

The first step portions 74 on the first stabilizing portion 62 need not always be rectangular step portions, and may alternatively be tapered step portions, as shown in FIGS. 11A, 11B and 11C. Since the gap K exists between the stabilizing plate 60 and the case 10, as mentioned before, the stabilizing plate is laterally dislocated by a margin equivalent to this gap when it is mounted. If the stabilizing plate 60 has the first step portions 74, the respective inside corners of the first step portions may possibly be situated inside the outermost peripheries of the data recording regions D3 of the magnetic disks 16a and 16b. As shown in FIGS. 11A, 11B and 11C, however, the first step portions 74 are tapered. Despite the dislocation of the mounted stabilizing plate 60, therefore, the stabilizing plate never fails to touch the outermost edge portions of the magnetic disks when subjected to an impact. Thus, the data recording regions can be securely prevented from being damaged.

Since the second embodiment shares other configurations with the foregoing first embodiment, like reference numerals are used to designate like portions of the two embodiments, and a detailed description of those portions is omitted. The second embodiment can provide the same functions and effects of the first embodiment.

Metal or resin may be suitably used as the material of the stabilizing plate 60. Metal has a high Young's modulus and is resistant to impact. If it is expected to a worked into a complicated three-dimensional shape having a stepped outer peripheral portion, for example, it entails high working cost, and the accuracy of the parts shape lowers. Although resin can be easily worked into a complicated shape at low cost by a molding method, on the other hand, its Young's modulus is so low that it is not very resistant to impact.

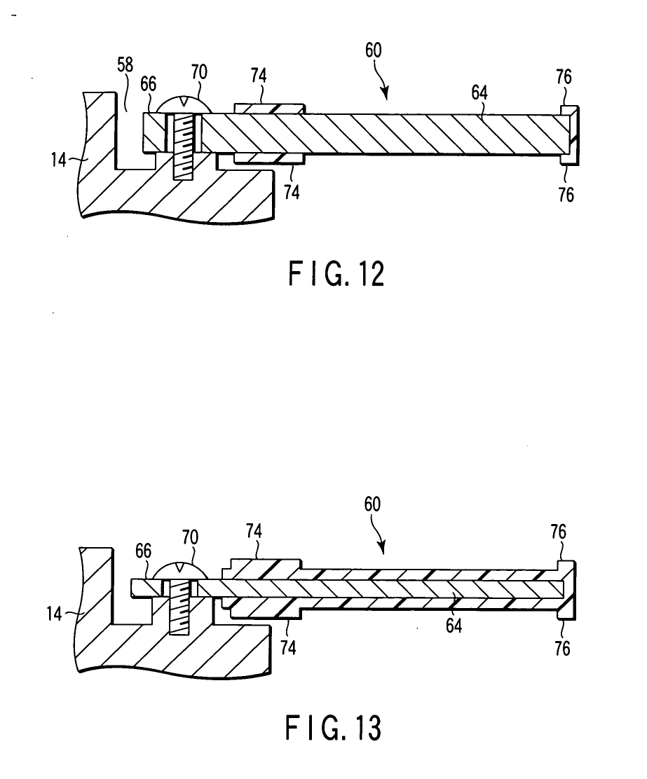

Thereupon, a flat portion of a stabilizing plate 60 may be formed of a flat metallic plate with only first and second step portions 74 and 76 as anti-shock means formed of resin, as shown in FIG. 12. According to this construction, most of the stabilizing plate 60 is formed of metal. Therefore, the first and second step portions 74 and 76 of resin can be freely molded into a complicated three-dimensional shape without failing to maintain high resistance to impact for the stabilizing plate 60 that is made mostly of metal. Since the metallic part is worked only two-dimensionally, the shape accuracy in its thickness direction can be enhanced. Since the first and second step portions 74 and 76 that touch the magnetic disks under impact are made of resin, moreover, dust cannot be easily produced by contact.

As shown in FIG. 13, a stabilizing plate 60 may be formed of a flat metallic plate with first and second step portions 74 and 76 formed by covering the surface of the metallic plate with resin. Also in this construction, the metallic part is flat, so that it requires no three-dimensional working.

The present invention is not limited directly to the embodiments described above, and its components may be embodied in modified forms without departing from the scope or spirit of the invention. Further, various inventions may be made by suitably combining a plurality of components described in connection with the foregoing embodiments. For example, some of the components according to the foregoing embodiment may be omitted. Furthermore, components according to different embodiments may be combined as required.

Although the HDD according to each of the foregoing embodiments has been described as being provided with two magnetic disks, the number of disks to be incorporated therein may be increased as required. If three or more magnetic disks are used, it is necessary only that a plurality of stabilizing members having the same configuration as aforesaid be successively arranged in layers.

What is claimed is:

1. A disk drive unit comprising:
a case;
a motor arranged in the case;
a plurality of disks which are individually supported and rotated by the motor;
a head which processes information for the disks;
a carriage assembly which is arranged in the case and supports the head for movement with respect to the disks; and
a stabilizing plate located between the plurality of disks and opposed to surfaces of the disks across gaps,
the stabilizing plate including an arcuate first stabilizing portion which has a first peripheral edge extending along respective outer peripheral edges of the disks and a second peripheral edge opposed to the first peripheral edge across a gap and which is opposed to the whole respective outer peripheral edge portions of the disks except a movement region for the carriage assembly; and a second stabilizing portion, which radially extends from one end portion of the first stabilizing portion toward respective central parts of the disks and is opposed to the movement region for the carriage assembly.

2. The disk drive device according to claim 1, wherein the second stabilizing portion is situated on an upstream side of the movement region for the carriage assembly with respect to a rotation direction of the disks.

3. The disk drive device according to claim 2, wherein the stabilizing plate is provided integrally with a third stabilizing portion which radially extends from the other end portion of the first stabilizing portion toward the respective central parts of the disks and is opposed to the movement region for the carriage assembly.

4. The disk drive device according to claim 1, wherein the second stabilizing portion is situated on a downstream side of the movement region for the carriage assembly with respect to the rotation direction of the disks.

5. The disk drive device according to claim 1, wherein the stabilizing plate integrally has a projection which is formed on one end of the first stabilizing portion and extends along respective outer peripheral edges of the disks and beyond the second stabilizing portion.

6. The disk drive device according to claim 1, wherein each of the disks has a first no-data recording region situated on the outer peripheral edge portion thereof, a second no-data recording region situated on the inner peripheral edge portion thereof, and a data recording region situated between the first and second no-data recording regions, and a space between the first and second peripheral edges of the first stabilizing portion is adjusted to 50% or less of a distance from the outer peripheral edge of each of the disks to the second no-data recording region.

7. The disk drive device according to claim 6, wherein the second stabilizing portion extends from the first stabilizing portion to a position opposite the second no-data recording region of each of the disks.

8. The disk drive device according to claim 1, wherein each of the disks has a first no-data recording region situated on the outer peripheral edge portion thereof, a second no-data recording region situated on the inner peripheral edge portion thereof, and a data recording region situated between the first and second no-data recording regions, and the first stabilizing portion has a first step portion which is opposed to the first no-data recording region of the disk and projects toward the disk so as to restrain the stabilizing plate from moving toward the disk.

9. The disk drive device according to claim 8, wherein at least a part of the first stabilizing portion has an extending portion which extends outward from the outer peripheral edge of the disk, the first step portion being provided on the extending portion.

10. The disk drive device according to claim 8, wherein the first step portion is tapered.

11. The disk drive device according to claim 8, wherein the second stabilizing portion extends from the first stabilizing portion to a position facing the second no-data recording region of each of the disks and has a second step portion which is opposed to the second no-data recording region of the disk and projects toward the disk so as to restrain the stabilizing plate from moving toward the disk.

12. The disk drive device according to claim 11, wherein the first and second stabilizing portions of the stabilizing plate are formed of metal, and the first and second step portions are formed of synthetic resin.

13. The disk drive device according to claim 11, wherein the first and second stabilizing portions of the stabilizing plate are formed of metal, and respective surfaces of the stabilizing portions are coated at least partially with synthetic resin.

14. The disk drive device according to claim 1, wherein the stabilizing plate has at least three support portions which project individually outward from an outer peripheral edge of the first stabilizing portion and are attached to the case, the center of gravity of the stabilizing plate being situated in a polygon having the support portions as vertices.

15. The disk drive device according to claim 14, wherein one of the at least three support portions is provided at the first stabilizing portion corresponding in position to a proximal end of the second stabilizing portion.

16. The disk drive device according to claim 14, wherein the case has a bottom wall on which the motor is mounted, a sidewall set up on a periphery of the bottom wall, an arcuate inner surface formed on the sidewall and opposed to the respective outer peripheral edges of the disks across gaps, and a plurality of fixing portions formed in the sidewall by cutting some parts of the arcuate inner surface, the support portions of the stabilizing plate are fixed individually in the fixing portions of the sidewall, and the stabilizing plate has a partition wall portion which is set up on at least one of the support portions and extends in alignment with the arcuate inner surface so as to close the corresponding fixing portion.

17. The disk drive device according to claim 14, wherein the stabilizing plate is formed of synthetic resin, and each of the support portions has a through hole for the passage of a screw and a metallic collar fitted in the through hole.
